(19) United States
(12) Patent Application Publication
(10) Pub. No.: US 2012/0138318 A1
(43) Pub. Date: Jun. 7, 2012

(54) Fire Truck and Other Vehicle Idle Reduction System

(75) Inventors: Bradley Weisz, Tea, SD (US); Scott Oyen, Crooks, SD (US)

(73) Assignee: Rosenbauer South Dakota, LLC, Lyons, SD (US)

(21) Appl. No.: 13/309,381

(22) Filed: Dec. 1, 2011

Related U.S. Application Data
(63) Continuation of application No. 12/641,190, filed on Dec. 17, 2009.

(51) Int. Cl. A62C 27/00

(52) U.S. Cl. 169/24

(57) ABSTRACT

A vehicle engine idle reduction system that shuts off the engine when the vehicle's parking brake has been engaged for a period of time; including a fire truck engine reduction system that shuts off the fire truck's engine when the fire truck is not pumping water.

### RELATED APPLICATION

The present invention is a continuation of U.S. patent application Ser. No. 12/641,190, of the same title, filed Dec. 17, 2009, incorporated herein in its entirety for all purposes.

### TECHNICAL FIELD

The present invention relates to fire truck and rescue vehicle engines and power systems.

### BACKGROUND OF THE INVENTION

Fire trucks consume a significant amount of gasoline or diesel fuel. As a result, they are both expensive to operate, and they produce an undesirably high amount of emissions. Also, fire trucks typically spent a significant amount of time sitting and idling on many of their emergency calls. This excessive idling is due to the following factors.

Nationally, about 90% of fire truck runs do not involve a fire. This is due to the fact that about 80% of runs are for emergency medical services calls, and about 10% are false alarms. In situations where fires are involved, the truck engine must be running to operate the water pumping system. In addition, however, power is also required to operate the various lighting systems and ventilation systems on the truck. Fire trucks also typically have plug in outlets on their sides to power plug in tools, equipment and remote lighting systems. As a result, the typical fire truck engine is simply kept running at all times when the fire truck is at the scene of an emergency call. As can therefore be appreciated, fire trucks spend a lot of time idling. This burns up a lot of fuel. Also, too much idle time can result in clogged diesel particulate engine filters which are expensive to service.

What is instead desired is a system to reduce the amount of time that a fire truck is spent sitting and idling, especially when it is not operating its water pumping system (which requires considerable power from the engine to operate). It is instead desirable to provide a system that shuts down an idling engine, yet has safety features such that the fire truck's battery charge is not simply depleted by the operation of the fire truck's lights (and/or its heating and cooling systems).

### SUMMARY OF THE INVENTION

The present invention provides a system for automatically shutting down an idling fire truck's engine, while ensuring that the truck's lighting system can still be operated without the danger of depleting the truck's battery. Preferably, the truck's ventilation and electrical systems can also be operated with the engine shut down.

In preferred aspects, the present invention provides a fire truck engine idle reduction system, comprising: a fire truck; an engine in the fire truck; an electrical power source in the fire truck; a water pumping system in the fire truck; a parking brake system in the fire truck; a system for determining whether the water pumping system is in pump mode; a system for determining whether the parking brake is engaged; and a system for shutting off the engine when the water pumping system is not in pump mode (i.e.: when water is not being pumped) and the parking brake is engaged. Preferably, the parking brake must be engaged for a pre-determined period of time before the system shuts off the engine.

In one preferred embodiment, the electrical power source simply comprises a battery. This battery may preferably be powerful enough to operate both the truck's lighting and ventilation systems when the engine is shut off. It is to be understood, however, that the present invention also encompasses embodiments in which the battery is only powerful enough to operate the lighting system when the engine is shut off. In addition, it is to be understood that this battery powering the vehicle when the engine is shut off may be a second battery or batteries (in addition to the standard vehicle engine starter battery).

In alternate embodiments, the electrical power source comprises a battery and an additional on-board generator. An alternator coupled to the generator charges the battery. The generator may be a diesel generator that is automatically turned on when the engine is shut off. In these embodiments, the combination of generator and battery provides a power source that is powerful enough to operate both the truck's lighting and ventilation systems when the truck's engine has been shut off. Optionally, this battery that is charged by the generator may preferably be a second battery or batteries (in addition to the standard vehicle engine starter battery). Alternatively, the battery that is charged by the generator may instead just be the standard vehicle engine starter battery.

Thus, the present invention encompasses designs with and without an onboard generator and designs with and without an additional battery (in addition to the standard vehicle engine starter battery).

In optional preferred aspects, the present invention further comprises: a battery monitoring safety system for determining the strength of the battery; and a system for restarting the chassis engine to charge the battery if the strength of the battery drops below a pre-determined level. The battery monitoring system may be a voltage meter that is part of a programmable logic control system.

It is to be understood that the present invention is not limited to fire trucks. Rather, it may be used with other rescue vehicles including ambulances, paramedic rescue vehicles and other vehicles lacking a water pumping system. In these instances, the present invention provides a rescue vehicle idle reduction system, comprising: a rescue vehicle; an engine in the rescue vehicle; an electrical power source in the rescue vehicle; a parking brake system in the rescue vehicle; a system for determining whether the parking brake is engaged; and a system for shutting off the engine when the parking brake is engaged.

The advantages of the present invention may include: (1) monetary savings by reduced fuel consumption; (2) reduced vehicle emissions; (3) very little additional cost per vehicle to install the present system; and (4) a longer life for the engine's diesel particulate filters. As a result of these “green” advantages, many local, state, and federal grants and programs will help to pay for this idle reduction technology.

### BRIEF DESCRIPTION OF THE DRAWINGS

FIG. 1 is a schematic perspective view of a first embodiment of the placement of the components of the present system in operation in a fire truck. (This embodiment includes an on-board generator).

FIG. 2 is a schematic perspective view of a second embodiment of the placement of the components of the present system in operation in a fire truck. (This embodiment does not include an on-board generator).

FIG. 3 is a schematic perspective view a of a first embodiment of the placement of the components of the present system in operation in a rescue vehicle. (This embodiment includes an on-board generator).

FIG. 4 is a schematic perspective view a of a second embodiment of the placement of the components of the present system in operation in a rescue vehicle. (This embodiment does not include an on-board generator).

### DETAILED DESCRIPTION OF THE DRAWINGS

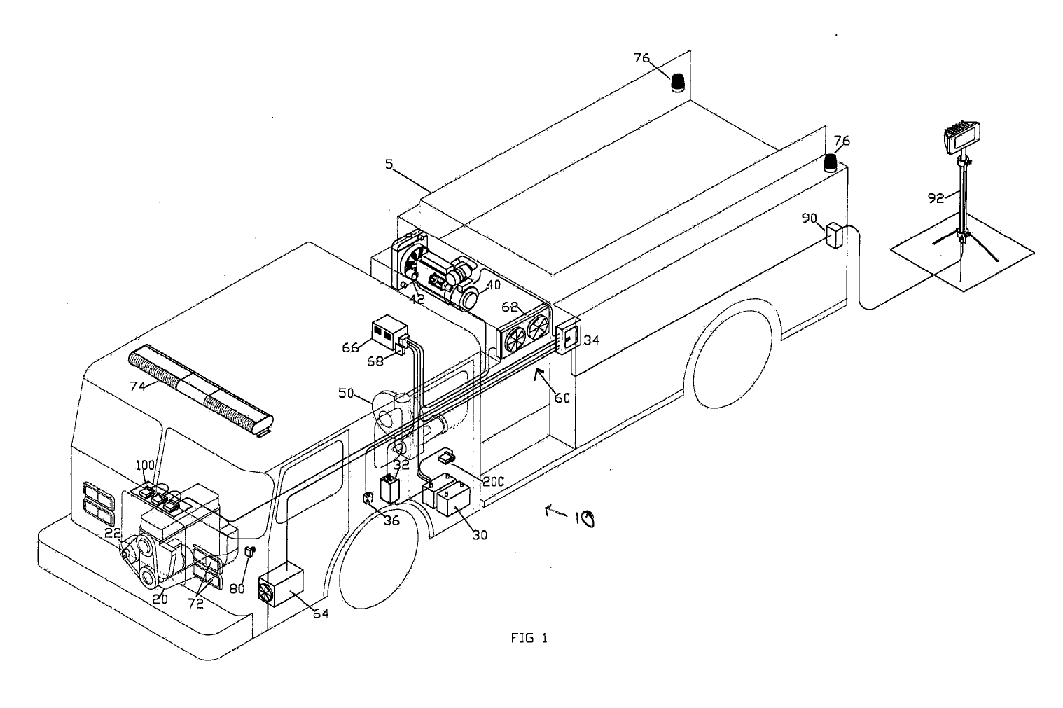

Referring first to FIG. 1, one embodiment of the present idle reduction system involves a variety of components placed at various locations around a fire truck, as follows.

A fire truck 5 is fitted with an idle reduction system 10. Idle reduction system 10 preferably comprises an engine 20, a battery 30; and a first alternator 22 connected to engine 20 for charging battery 30. System 10 also comprises an onboard generator 40, with a second alternator 42 for charging battery 30. A water pumping system 50 is also provided. As is typical of fire trucks, water pumping system 50 requires significant power and is powered by engine 20. (As such, the fire truck pumps water when its engine 20 is turned on. This design is typical of all standard fire trucks.) A ventilation system 60 is also provided. Ventilation system 60 can be used to heat (and/or cool) the truck cab. Ventilation system 60 is powered by battery 30. (Note: battery 30 will preferably be the standard engine starter battery, however, it may also be an additional installed battery). A lighting system 70 is also provided. As is well known, fire trucks have numerous lights which are operated both as the truck rushes through traffic and when the truck is stopped at the scene of an emergency. Therefore, lighting system 70 operates to run both flashing headlights and flashing top/side lights, as well as interior cab lights on the truck. Lighting system 70 is also powered by battery 30. Fire truck 5 also has a standard parking brake system 80.

In accordance with the present invention, the idle reduction system includes logic circuit systems 100 for: (a) determining whether the water pumping system 50 is in its “pump mode” (i.e.: the system is actively turned on to pump water or is pumping water); and (b) determining whether parking brake 80 is engaged. Once these two systems have determined that both the water pumping system 50 is not in its “pump mode” and that parking brake 80 is engaged, then a third system (c) is provided to shut off engine 20 and start generator 40.

As a result, system 10 automatically turns off engine 20 and starts on board generator 40 when the water pumping system 50 is not pumping and the parking brake 80 is engaged. When parking brake 80 is engaged for a pre-determined period of time, the system for shutting off the engine and starting the generator shuts off the engine and starts the generator. If the time period is too short, the engine may shut off too soon after arriving at the scene of the call, and may need to be quickly restarted. Conversely, if the time period it too long, the truck will simply burn up more fuel before being turned off. In preferred embodiments, the pre-determined period of time before system 10 turns off engine 20 and starts generator 40 is typically adjustable from 30 to 60 seconds.

System 10 is therefore very advantageous in that (when turned on) it operates automatically. Therefore, when firefighters arrive on a scene they can park their vehicle and respond to the emergency. If the situation is not a fire, then the pumping system 50 is never set into its active “pump mode”. The firefighters simply leave the cab of the vehicle and attend to the emergency. After the predetermined period of time, system 10 will then automatically turn off engine 20 and activate onboard generator 40. The result is that generator 40 keeps the truck's batteries 30 charged. Thus, batteries 30 can keep lighting system 70 and ventilation system 60 operating. In addition, generator 40 can also provide power to any of the plug in electrical components (e.g.: flood lamp 92) plugged into one of the electrical outlets 90 on the exterior surface of the fire truck.

It is of course important to make sure that battery 30 does not become depleted when engine 20 is turned off and ventilation system 60, lighting system 70 and electrical outlets 90 are all in use. Therefore, in optional preferred embodiments, a safety system 200 is included, as follows. Safety system 200 (which may be a component of system 100) includes both: (a) a battery monitoring system for determining the strength of battery 30; and (b) a system for restarting engine 20 to charge battery 30 if the strength of battery 30 drops below a pre-determined level.

The Applicants have constructed and operated an embodiment of the present invention. Further details of the particular components used are described below. However, it is to be appreciated these descriptions are merely exemplary and that the present invention is not limited to these specific components.

Fire truck 5 was a pumper system as made by Rosenbauer Firefighting Technology (or Central States Fire) of Lyons, S. Dak. Engine 20 was a Detroit Diesel made by Detroit Diesel corporation. Battery 30 was a standard automotive battery. On board generator 40 was a Tier 4 Kubota diesel 1800 rpm engine and Pancake Generator made by Marathon corporation. When powering lighting system 70 and ventilation system 60 and maintaining the charge in battery 30, onboard generator 40 consumes approximately 1.25 liters of fuel/hr.

The electrical system can also comprise a battery charger 32, shoreline connection 36 and a circuit breaker 34. Shoreline connection 36 is an outlet into which the fire truck is plugged when it is sitting in the fire house. The shoreline connection 36 ensures that the battery 30 remains fully charged, and maintains the chassis temperature by powering compressor and condenser 64 when the truck is sitting in the firehouse. Circuit breaker 34 directs the shoreline power to the battery charger 32, which then charges battery 30 and directs power from generator 40 to battery charger 32 which charges battery 30. Shoreline plug battery charger 32 was a NewMar battery charger that is capable of a continuous 40 AMP (or optional 80 AMP) charge. This battery charger 32 maintains the batteries at peak charge when running on shoreline power.

The shoreline receptacle 36 was rated for 20 AMPS at 120V. It helps maintain the interior temperature of the cab by operating ventilation system 60 on a low output setting. This keeps the interior cool and free from excess moisture. The shoreline plug 36 also has an auto-eject feature that unplugs the cable from the receptacle when the chassis ignition button is depressed, ensuring the fire truck leaves the firehouse without dragging a power cord. The workload of shoreline receptacle 36 is taken over by onboard generator 40 when the vehicle is in the idle reduction mode.

Pumping system 50 was a waterous CSUCIOC single stage 1,500 gallon/min single stage pump. (However, it is to be understood that any suitable pumping system can be used). Ventilation system 60 included a compressor and condenser 62 for maintaining cabin environment when in idle reduction mode and not plugged into shoreline power, and an air conditioning compressor and condenser 64 for maintaining cabin environment when the station and shoreline power is connected. Also included was a air conditioning and heating unit 66, having a controlling thermostat 68; and an air conditioning compressor 69 (driven by onboard generator 40). Ventilation system 60 provided 650 CFM of air flow and 32,000 BTU of thermostatically controlled cooling power in a 12VDC system. Lighting system 70 includes front lights 72, top lights 74, and top rear lights 76. Other lights (including interior cabin lights) are included as well.

Idle reduction system 10 is controlled by programmable controllers 100 in the cab of the fire truck. Battery monitoring safety system 200 can comprise logic circuits that are housed near battery 30. The engine re-starts when the battery voltage drops to less than or equal to 12.2VDC. It is to be understood that the battery monitoring safety system 200 for both battery 30 and 110 can be integrated into a single system.

The advantage of using onboard generator 40 is that it consumes so much less fuel than engine 20. Engine 20 and generator 40 share a main fuel reservoir; however, the present invention also covers alternate truck and rescue vehicle designs wherein the engine and generator do not share the same fuel reservoir.

Therefore, the present invention also includes a method of reducing fire truck engine idling, by: operating a fire truck with an idle reduction system configured to: (a) determine if a water pumping system on the fire truck is in pump mode; (b) determine if the parking brake on the fire truck is engaged; and then (c) shut off the engine after a pre-determined amount of time has elapsed and start an on board generator to charge the fire truck battery when the water pumping system is not in pump mode and the parking brake is engaged.

Optionally, this method further comprises: monitoring the strength of the battery; and restarting the engine to charge the battery if the strength of the battery drops below a pre-determined level.

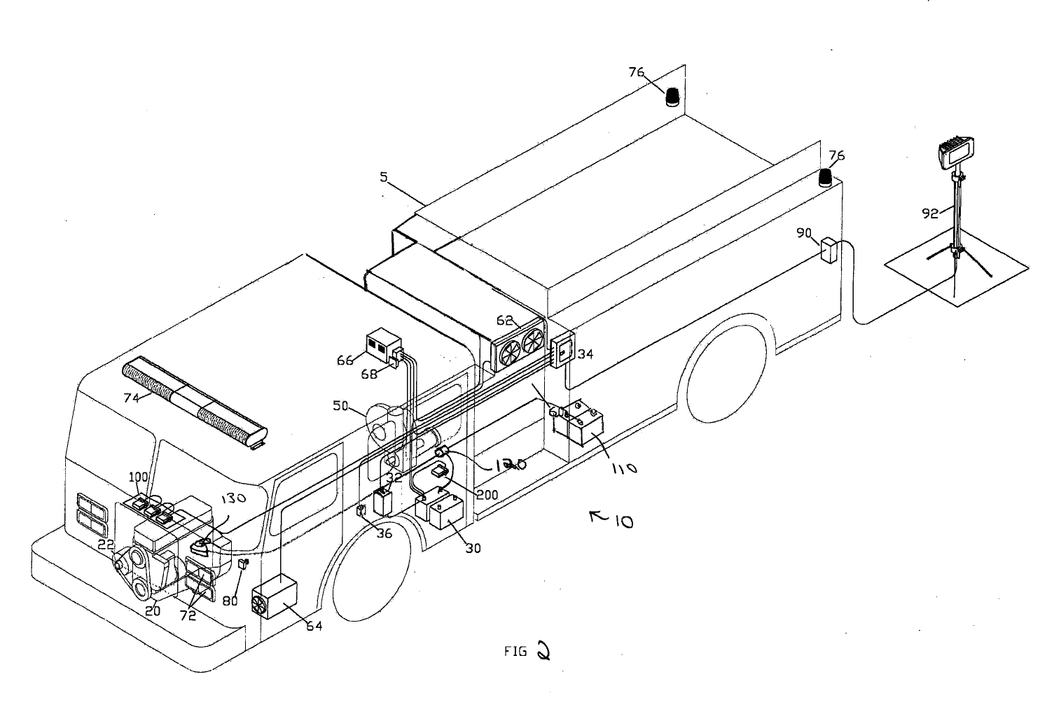

FIG. 2 illustrates a second embodiment of the invention in which the electrical power source is auxiliary battery 110. (This is in contrast to the system of FIG. 1 where the electrical power source was a battery 30, alternator 42 and a generator 40). Thus, the embodiment of FIG. 2 uses only battery 110 to provide electrical power when engine 20 has been shut off. Simply put, in the embodiment of FIG. 2, there is no generator 40. In addition, a master power switch 130 and battery selector device 120 are also provided. Master power switch 130 selects either of (standard engine) battery 30 or auxiliary battery 110 to power the fire truck's electrical systems. When the engine is on, battery 30 powers the electrical systems. When the engine is off, auxiliary battery 110 powers the fire truck's electrical systems. Preferably, battery 110 is more powerful than battery 30 (since battery 110 will be running the electrical systems when the engine is off (i.e.: not charging the battery). In accordance with the present invention, each of battery 30 and battery 110 can be recharged by the engine's alternator when the engine is running.

As can be expected, the embodiment of FIG. 2 will either comprise: (a) a battery 110 that is only strong enough to power lighting system 70 (and not ventilation system 60), or (b) a battery 110 that is strong enough to power both lighting system 70 and ventilation system 60. In the embodiments where battery 110 is sufficiently strong to power both lighting system 70 and ventilation system 60, battery 110 may optionally be a high power lithium polymer battery or a high amp deep cycle battery. Preferably, battery 110 in FIG. 2 will be powerful enough to provide three or more hours of operation to lighting system 70 after engine 20 has been shut off. When battery 110 is a strong lithium polymer battery, it preferably provides eight or more hours of operation to lighting system 70 after engine 20 has been shut off. Thus, battery 110 may be powerful enough to power ventilation system 60 after engine 20 has been shut off without a generator (40 in FIG. 1) being present to charge battery 110 when engine 20 is shut off. Therefore, it is to be understood that the duration of time during which battery 110 powers lighting system 70 and ventilation system 60 after engine 20 has been shut down depends upon the respective draws of systems 60 and 70. For example, if ventilation system 60 is only operating an air fan, battery 30 can provide power longer than if ventilation system 60 is instead also heating or cooling the truck cab. It is also to be understood that any of the functions attributed to battery 110 herein may also be done by battery 30 (provided that battery 30 is sufficiently strong). This is because the present invention encompasses embodiments with a separate (engine starter) battery 30 and (auxiliary) battery 110, and embodiments where batteries 30 and 110 are combined into a single battery.

In the aspect of the invention in FIG. 2, (in which generator 40 in FIG. 1 is not included), it is desirable to include a system that re-starts engine 20 should the strength of battery 110 fall below a certain pre-set level. Thus, should battery 110 be drained too far by the operation of lighting system 70 (and possibly ventilation system 60 as well), then engine 20 will automatically be switched back on to turn alternator 22, and re-charge battery 110.

Optionally as well, a safety system can be included to cause the truck horn to honk should the power in battery 110 (or 30) fall below a safety level and engine 20 fail to restart. This safety system can be included in either of the embodiments shown in FIG. 1 or 2.

As was stated above, the present invention is not limited to fire trucks. Rather, it is equally well suited to vehicles that do not pump water (including ambulances and paramedic rescue vehicles). In such applications, the only real difference is that the idle reduction system does not have to determine whether the vehicle is in “pump mode”. Instead, all that is required is a system 100 that will (a) determine whether the parking brake is engaged; and (b) shut off the engine and start the generator when the parking brake has been engaged, preferably for a pre-determined period of time.

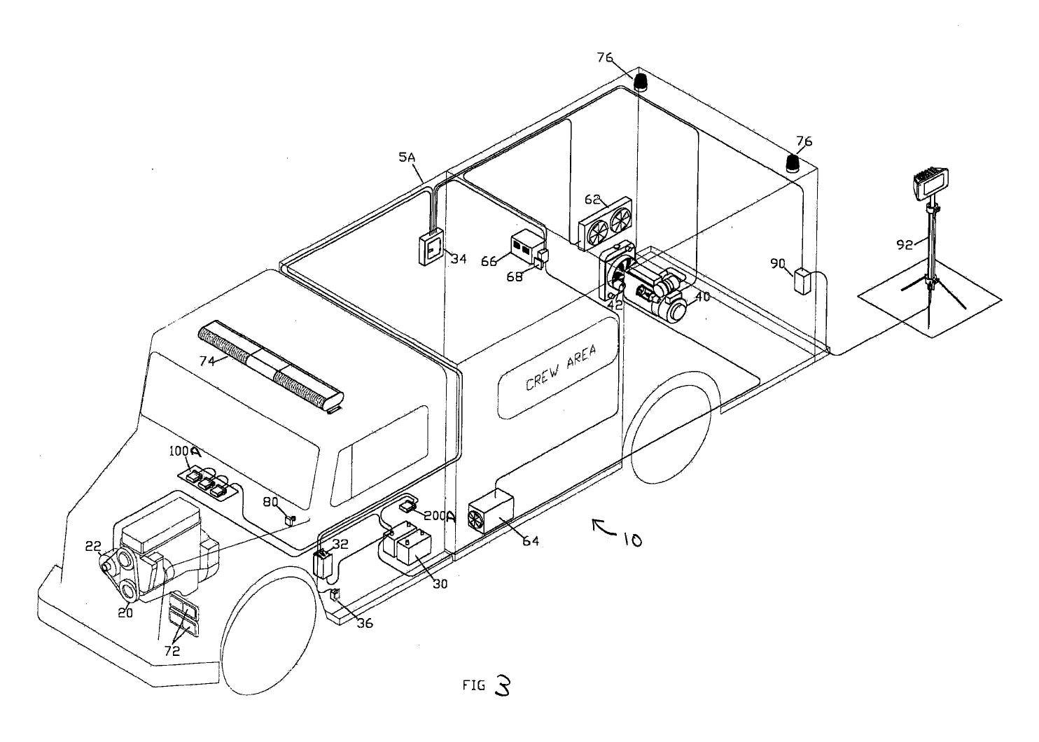

Specifically, as seen in FIG. 3, these embodiments of the invention provide a rescue vehicle idle reduction system, comprising: a rescue vehicle (ambulance 5A); an engine 20 in the rescue vehicle; a battery 30 in the rescue vehicle; an alternator 22 connected to the engine for charging the battery; a generator 40 in the rescue vehicle; an alternator 42 connected to generator 40 for charging battery 30. A ventilation system 60 and lighting system 70 are both powered by battery 30. A parking brake system 80 is also provided.

System 100A then (a) determines whether the parking brake is engaged; and (b) shuts off the engine and starts the generator when it is determined that the parking brake has been engaged for a pre-determined period of time. A safety system 200A (similar in operation to system 200 described above) can also be included.

As such, the present invention also includes the method of reducing idling time in a rescue vehicle, by: operating a rescue vehicle with an idle reduction system configured to: (a) determine if the parking brake on the rescue vehicle is engaged; and then (b) shut off the engine and start an on board generator to charge the rescue vehicle battery when the parking brake has been engaged for a predetermined period of time.

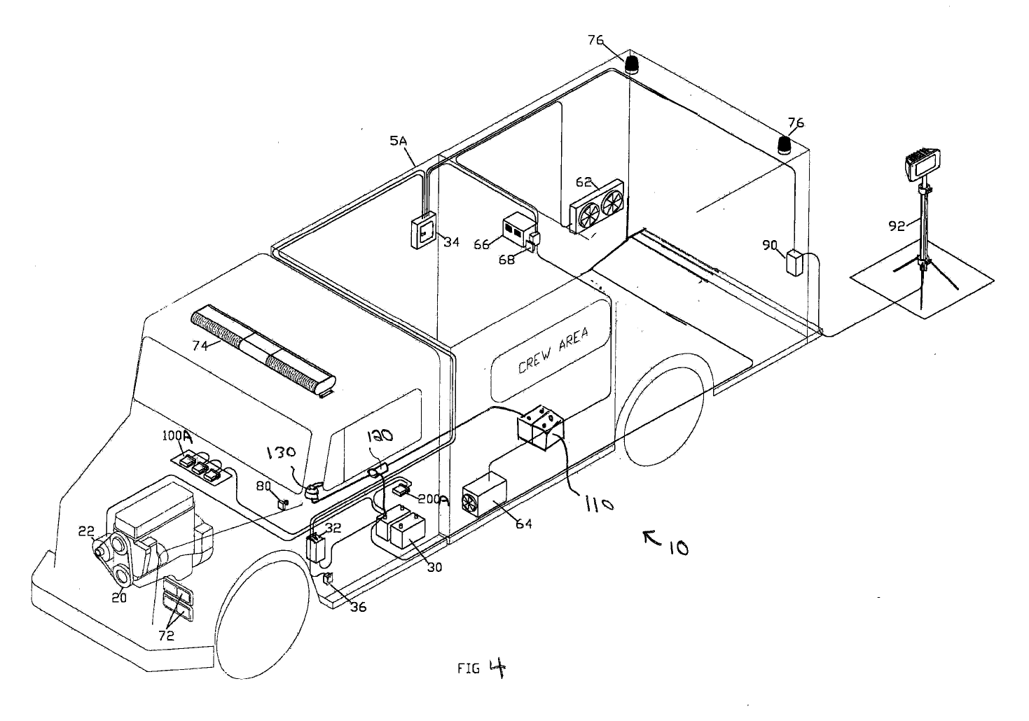

Lastly, FIG. 4 shows a second embodiment of the present invention used in a rescue vehicle. In this embodiment, generator 40 and associated alternator 42 (from FIG. 3) have been removed, and auxiliary battery 110 powers lighting system 70 when engine 20 has been shut off. Similar to the embodiment of FIG. 2, battery 110 will preferably be high power lithium polymer battery or a high amp deep cycle battery. In addition, it is desired to include a system that re-starts engine 20 should the strength of battery 110 (or 30) fall below a certain pre-set level. Thus, should battery 110 be drained too far by the operation of lighting system 70 (and possibly ventilation system 60 as well), then engine 20 will automatically be switched back on to turn alternator 22, and re-charge battery 110 (and/or 30).

What is claimed:

1. A fire truck engine idle reduction system, comprising:
a fire truck;
an engine in the fire truck;
an electrical power source in the fire truck;
a water pumping system in the fire truck;
a parking brake system in the fire truck;
a system for determining whether the water pumping system is in pump mode;
a system for determining whether the parking brake is engaged; and
a system for shutting off the engine when the water pumping system is not in pump mode and the parking brake is engaged.

2. The system of claim 1, wherein the system for shutting off the engine when the water pumping system is not in pump mode and the parking brake is engaged activates the electrical power source to provide power to at least one of:
a ventilation system in the fire truck; or
a lighting system in the fire truck.

3. The system of claim 1, wherein the electrical power source comprises a generator, an alternator and a battery.

4. The system of claim 3, wherein the generator turns the alternator to charge the battery, and wherein the battery provides power to both:
a ventilation system in the fire truck; and
a lighting system in the fire truck,
when the engine is shut off.

5. The system of claim 3, wherein the generator is a diesel generator.

6. The system of claim 1, wherein the electrical power source comprises a battery.

7. The system of claim 6, wherein the battery powers at least one of:
a ventilation system in the fire truck; or
a lighting system in the fire truck,
when the engine is shut off.

8. The system of claim 7, wherein the battery powers both the ventilation system and the lighting system when the engine is shut off.

9. The system of claim 7, wherein the battery powers the lighting system but does not power the ventilation system when the engine is shut off.

10. The system of claim 6, wherein the battery is a lithium polymer battery.

11. The system of claim 6, wherein the battery is a deep cycle battery.

12. The system of claim 1, wherein the power source comprises a battery, further comprising:
a battery monitoring system for determining the strength of the battery; and
a system for restarting the engine to charge the battery if the strength of the battery drops below a pre-determined level.

13. The system of claim 1, wherein the parking brake must be engaged for a pre-determined period of time before the system for shutting off the engine shuts off the engine.

14. The system of claim 1, further comprising:
an electrical outlet system on the fire truck, the electrical outlet system comprising outlets that are powered by the electrical power source in the fire truck.

15. The system of claim 1, further comprising:
a shoreline power receiver mounted on the fire truck for receiving external power to charge the electrical power source.

16. A rescue vehicle engine idle reduction system, comprising:
a rescue vehicle;
an engine in the rescue vehicle;
an electrical power source in the rescue vehicle;
a parking brake system in the rescue vehicle;
a system for determining whether the parking brake is engaged; and
a system for shutting off the engine when the parking brake is engaged.

17. The system of claim 16, wherein the system for shutting off the engine when the parking brake is engaged activates the electrical power source to provide power to at least one of:
a ventilation system in the rescue vehicle; or
a lighting system in the rescue vehicle,
when the engine is shut off.

18. The system of claim 16, wherein the electrical power source comprises a battery.

19. The system of claim 18, wherein the electrical power source further comprises a generator and an alternator for charging the battery.
